(19) United States
(12) Patent Application Publication
(10) Pub. No.: US 2002/0175826 A1
(43) Pub. Date: Nov. 28, 2002

(54) Traffic signal having electronically reconfigurable LED array

(76) Inventors: Michael C. Hutchison, Plano, TX (US); Kevin Ovens, Plano, TX (US)

Correspondence Address: Robert C. Klinger, Jackson Walker, L.L.P., 2435 North Central Expressway, Suite 600, Richardson, TX, 75080, US

(21) Appl. No.: 09/826,785

(22) Filed: Apr. 5, 2001

(51) Int. Cl. G08B 5/22

(52) U.S. Cl. 340/815.45; 340/907; 340/908

(57) ABSTRACT

A reconfigurable LED array (22) having LED sets (26, 28, 30) in series with a main LED array (24). The LED array (22) is controlled as a function of the operating DC voltage such that as the operating DC voltage level drops, selective ones of the LED strings are shunted so that the remaining LEDs of the array (22) are operational. The operational LEDs are PWM controlled such that the overall light intensity generated by the operational LEDs meets DOT requirements. The LED sets (26, 28 30) are connected in series with the main LED (24) as is stacked logic (62, 64) along with a voltage regulator (60).

### TECHNICAL FIELD OF THE INVENTION

The present invention is generally related to traffic control signals, and more particularly to LED traffic control signals that are subjected to varying DC control voltages.

### BACKGROUND OF THE INVENTION

Traffic control signals have traditionally implemented incandescent light sources for years. More recently, light emitting diode (LED) arrays are finding acceptance as substitute light sources for incandescent lights and since they provide several advantages over traditional incandescent lights. LEDs operate off direct current (DC) voltage sources as opposed to the incandescent lamps powered by AC voltage sources, and are efficient in generating light as a function of consumed power.

One problem faced using DC powered LED light sources is a reduction in operating DC voltage levels, particularly during a system malfunction or failure. For instance, a single LED array may be designed to operate from a 48 volt DC source, yet which may not be designed to operate below 44 volts DC. Consequently, the entire LED array may fail to generate any light during such a low voltage condition.

For safety reasons, the Department of Transportation (DOT) may require that LED signals operate at a greatly reduced voltage. For instance, a 48 volt red LED light needs to operate at 35 volts to allow an intersection to go into a flashing red mode if a problem is detected by the intersection controller. It is not unusual in an intersection to have four lights connected to the controller through a resistance of over three (3) ohms. With four lights requiring one amp of current, there is over a 12 volt drop in the power lines extending between the intersection controller and the lights.

To meet the DOT requirements, there is needed an improved LED light array that is adapted to properly operate at a significantly lower DC voltage than a nominal voltage, such as at 35 volts when designed as a 48 volt LED system. Such a LED light should be operable at this lower DC voltage condition for both normal operation and also for a flashing mode of operation during a system problem.

### SUMMARY OF THE INVENTION

The present invention achieves technical advantages as a reconfigurable LED array having a plurality of LED sets, each LED set adapted to be enabled for a different DC operating voltage.

In one preferred embodiment, the LED array is configured as four sets of LEDs, one main array and three additional LED arrays. At a lower most specified operating DC voltage, such as 35 volts, only the main LED array is PWM driven. However, as the operating voltage increases to 48 volts, the other three LED arrays are selectively driven to increase light output as the operating voltage increases. In a normal mode of operation, such as at a nominal 48 volts, all LED sets are driven. Through pulse width modulation (PWM) control, the duty cycle of drive time is increased for lower operating voltages to provide an acceptable amount of light output provided by the LED array during normal operation and a flashing mode.

In one preferred implementation, the sets of LEDs comprised in the LED array are coupled in series between a positive voltage rail and stacked logic circuitry, whereby a reference voltage is defined at a node between the LED array and the logic circuitry. A voltage regulator controls the voltage at the reference node, and control circuitry, using the reference node, responsive to the voltage needed to drive the LED array controls which, if any, of the LED sets are driven. A shunt, such as a FET, is provided in parallel across each set of LEDs. Control logic selectively enables the shunt transistors to electrically bypass the associated set of operative LEDs from the string of LED sets. Thus, the series of LED sets can be selectively enabled, such that one, two, three or all four of the LED sets can be enabled and pulsed with modulated to achieve a desired light output, even as the DC voltage degrades from a pre-determined specified level, such as 48 volts, all the way down to roughly 29 volts.

### BRIEF DESCRIPTION OF THE DRAWINGS

FIG. 1 is a perspective view of an LED light apparatus having a reconfigurable LED array according to the present invention;

FIG. 2 is a block diagram of the reconfigurable LED array according to the present invention;

FIG. 3 is a schematic diagram of the control logic for the LED array generating a plurality of control signals as well as a reference voltage;

FIG. 4a is a schematic of the sets of LEDs configured in series and their associated bypass shunt transistors such that selected sets of LEDs are enabled as a function of the operating DC voltage,

FIG. 4b is a schematic of the PWM drive circuitry for the LEDs indicated in FIG. 4a, and the voltage sensing circuitry that determines if the LED array should be reconfigured; and

FIG. 5 is a schematic diagram of the optical feedback circuitry for the LED array.

### DETAILED DESCRIPTION OF THE PREFERRED EMBODIMENT

Referring now to FIG. 1, there is generally shown at 10 a perspective view of a LED light apparatus having a reconfigurable LED array generating a light output therefrom. The light 10 has a lens 12, which lens 12 may be colored if desired to color the generated light transmitted therethrough such as to a red, green, yellow, or orange light, or simply left transparent in a case when an internal device such as a colored light diffuser is implemented.

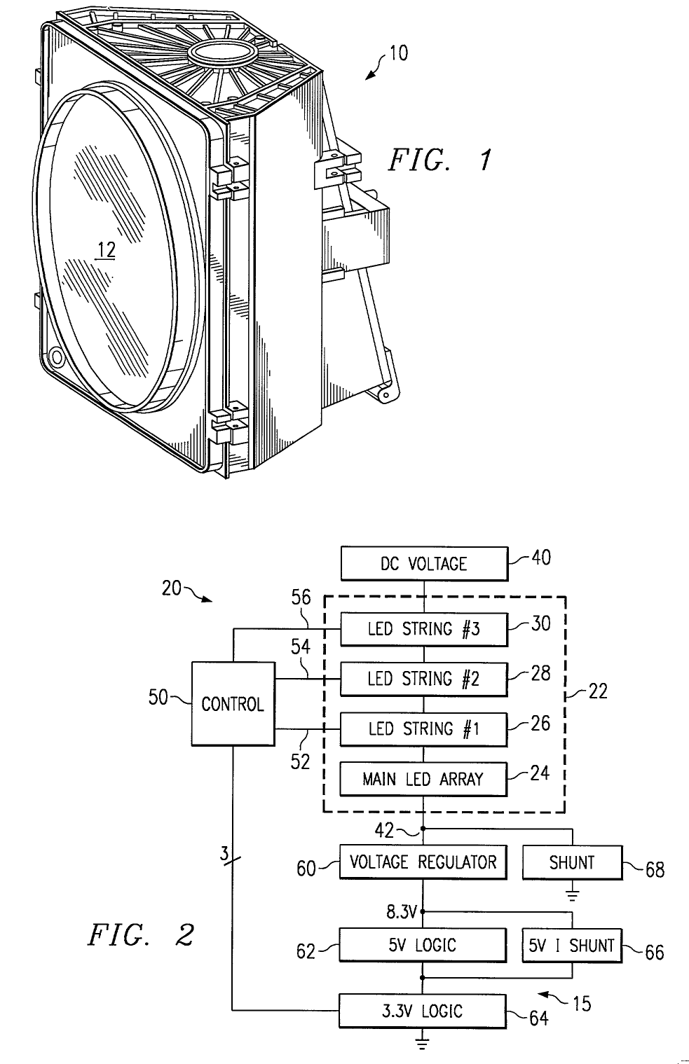

Referring to FIG. 2, there is illustrated at 20 a block diagram of the reconfigurable LED light array having a reconfigurable LED array 22 comprised of a main LED array 24, a first LED string 26, a second LED string 28, and a third LED string 30. All LED sets are connected in series between a DC operating voltage source 40 and a reference voltage node shown at 42. A control circuit 50 selectively enables the LED strings 26, 28 and 30 via control lines 52, 54 and 56, respectively, as a function of the DC voltage provided to the LED array 22 by voltage source 40.

By way of example, the light apparatus may be designed to operate from a nominal voltage of 48 voltage DC depicted as voltage source 40. Voltage source 40 may, in some embodiments, be the DC voltage provided by the remote light system controller, as described in the background of the invention section, and which DC voltage may degrade over time due to the losses over the power line or other system failures.

For instance, in the preferred embodiment, there is a binary weighting of the number of LEDs between the groups of LED strings #1, #2, and #3, such that LED string #3 has 1 LED, string #2 has 2 LEDs and string #1 has 4 LEDs. This allows an array reconfiguration resolution of 1 LED. When the operating DC voltage 40 is reduced from the nominal voltage, such as from 48 volts to 46 volts, the LED string 30 will be shunted such that DC voltage source 40 powers the remaining LED string 28, LED string 26, and the main LED array 24. If the DC voltage 40 degrades to a second predetermined threshold, such as 42 volts, then the second LED string 28 is shunted, such that the DC voltage 40 is coupled to the remaining operational LED strings 30, string 26 and the main LED array 24. If the DC voltage 40 degrades to a third pre-determined threshold, such as 38 volts, then the first LED string 30 and second LED string 28 is shunted, such that the DC voltage 40 is coupled to the remaining operational LED string 26 and the main LED array 24. As the DC voltage drops further, the LED strings are shunted in a binary code as shown in the table below:

| DC Voltage Range | STRING 3 | STRING 2 | STRING 1 |
|---|---|---|---|
| Over 46 | ON | ON | ON |
| 46-43 | OFF | ON | ON |
| 43-40 | ON | OFF | ON |
| 40-37 | OFF | OFF | ON |
| 37-34 | ON | ON | OFF |
| 34-30 | OFF | ON | OFF |
| 30-27 | ON | OFF | OFF |
| Under 27 | OFF | OFF | OFF |

In a worse case operating mode, say when the operating DC voltage drops to 27 volts DC, all three of the supplemental LED strings 26, 28 and 30 are shunted, such that the operating DC voltage 40 is provided to the main LED 24 and only the main LED array 24 is operational and generating light. Each of the enabled main LED array 24, as well as the serially connected LED strings 26, 28 and 30 are pulse width modulated (PWM) whereby the duty cycle is controlled by a control circuit 50 to provide a pre-determined light output from the active LEDs to insure that light generated meets DOT requirements.

In an alternate embodiment, a linear weighting (instead if binary weighting) can be used for the LED strings. In this case, when the operating DC voltage 40 is reduced from the nominal voltage, such as from 48 volts to 45 volts, the LED string 30 will be shunted such that DC voltage source 40 powers the remaining LED string 28, LED string 26, and the main LED array 24. If the DC voltage 40 degrades to a second pre-determined threshold, such as 38 volts, then the second LED string 28 is shunted as well, such that the DC voltage 40 is coupled to the remaining operational LED string 26 and the main LED array 24. In a worse case operating mode, say when the operating DC voltage drops to 29 volts DC, all three of the supplemental LED strings 26, 28 and 30 are shunted, such that the operating DC voltage 40 is provided to the main LED 24 and only the main LED array 24 is operational and generating light. Each of the enabled main LED array 24, as well as the serially connected LED strings 26, 28 and 30 are pulse width modulated (PWM) whereby the duty cycle is controlled by a control circuit 50 to provide a predetermined light output from the active LEDs to insure that light generated meets DOT requirements.

Still referring to FIG. 2, there is shown a voltage regulator 60 coupled in series between the LED array 22 and stacked logic 62 and 64 as shown. In this embodiment, there is provided a 3.3 volt logic circuit 64 and a 5 volt logic circuit 62 coupled in series to form a stacked logic circuit as shown. A current shunt 66 is provided in parallel with the 5 volt logic circuit 62 to shunt the current drawn by the LED array 22 but not required by the 5 volt logic circuit 62. For instance, the LED array 22 may be designed to draw up 40 milliamps, and the 5 volt logic circuit 62 may draw up 25 milliamps with the shunt 66 drawing 15 milliamps. The voltage regulator 60 regulates the reference voltage at the reference node 42, and is also provided with a shunt 68 in parallel therewith and coupled to ground to provide an increase in LED current when the current required for the logic is not enough to illuminate the LED to the desired level. Preferably, the 3.3 volt logic circuit 64 is comprised of a programmable logic device (PLD), microcontroller, or DSP having three output control lines, as shown, being coupled to the control circuit 50 for the selective control therewith as will now be described in more detail.

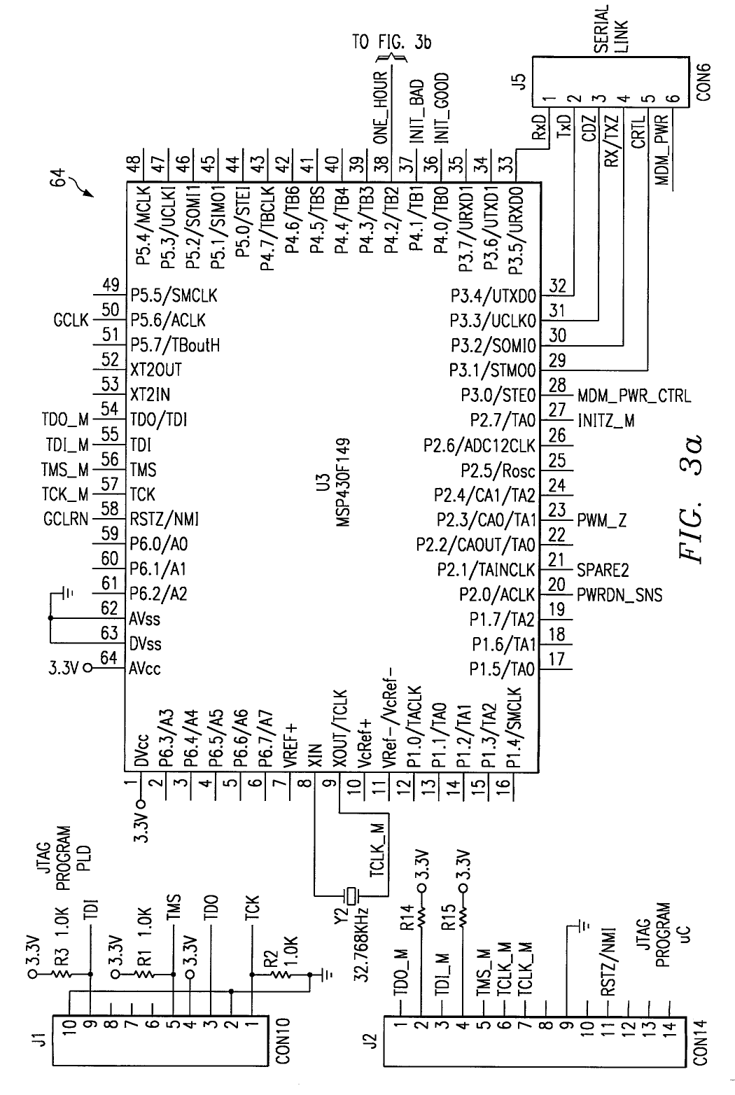

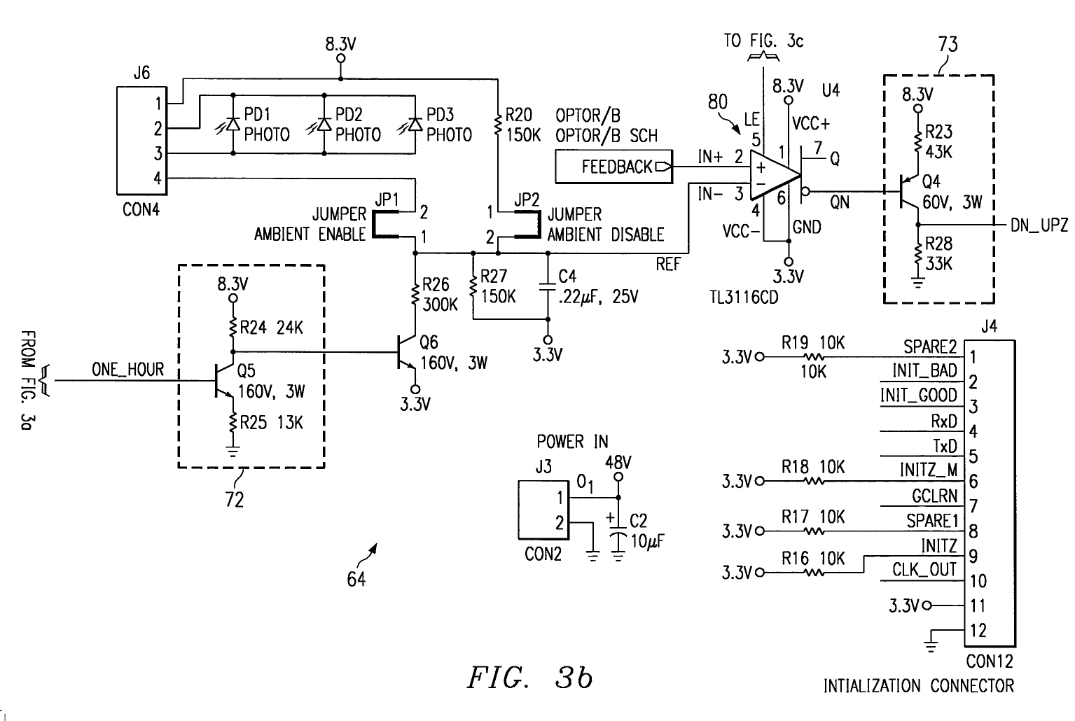

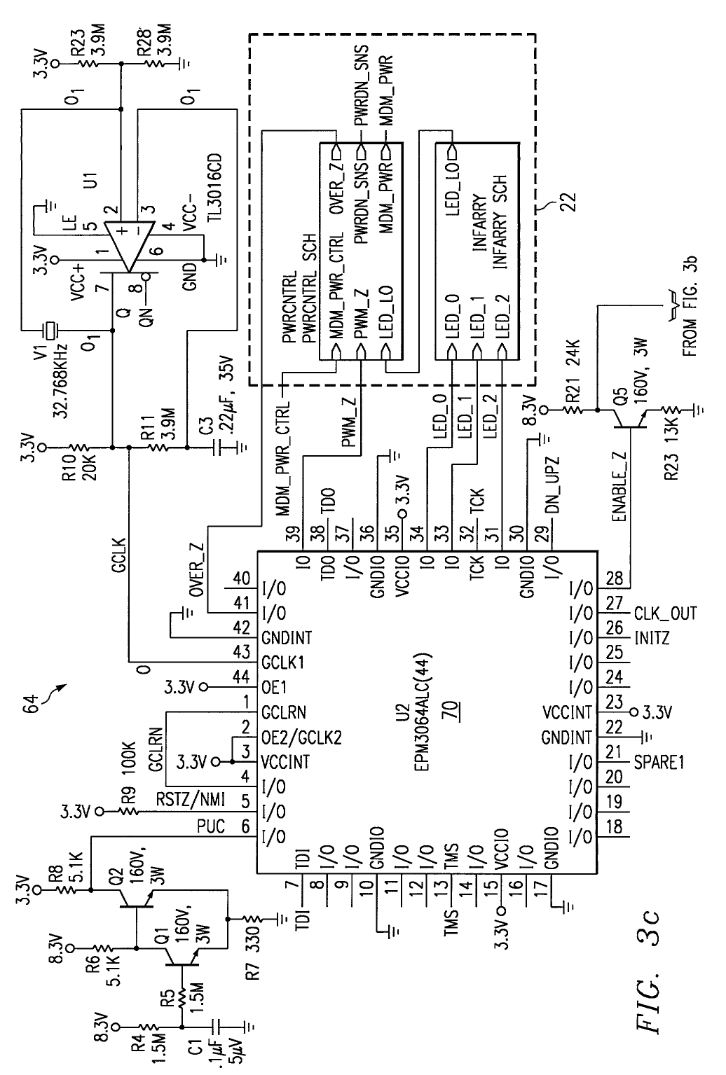

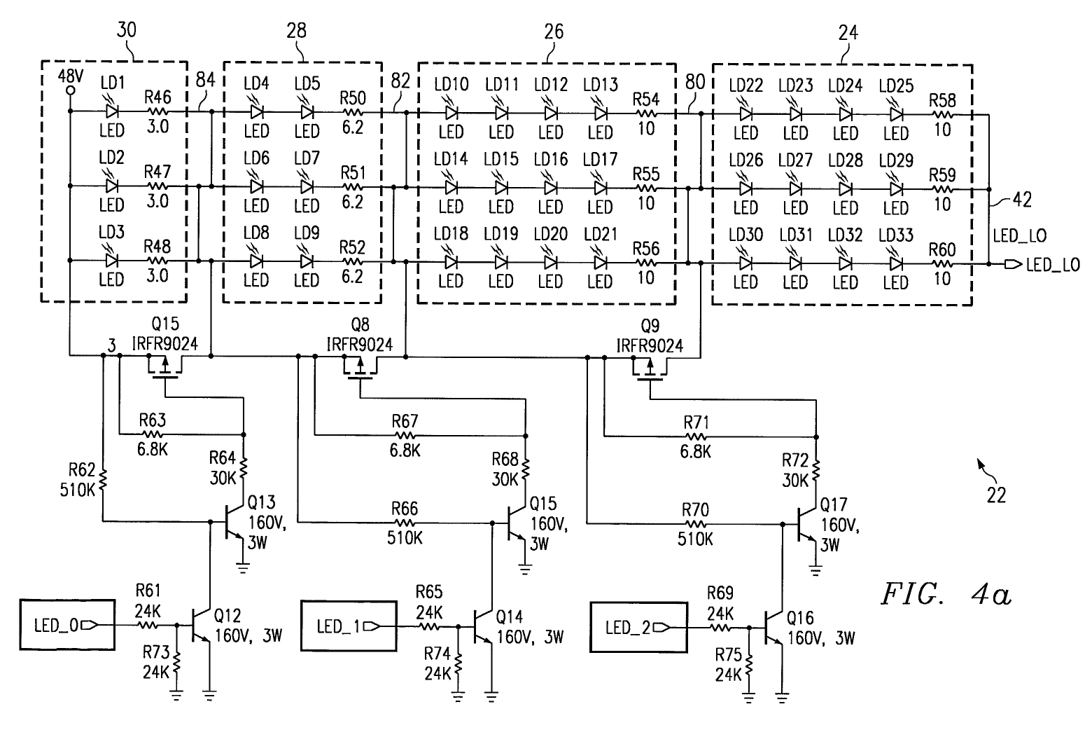

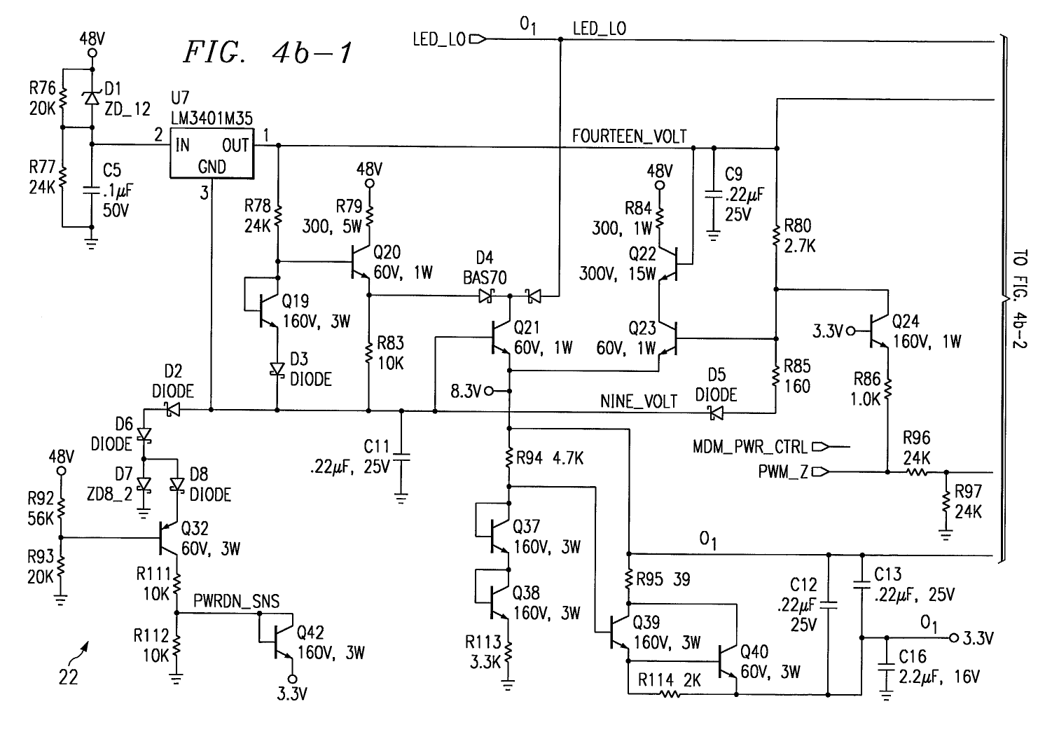

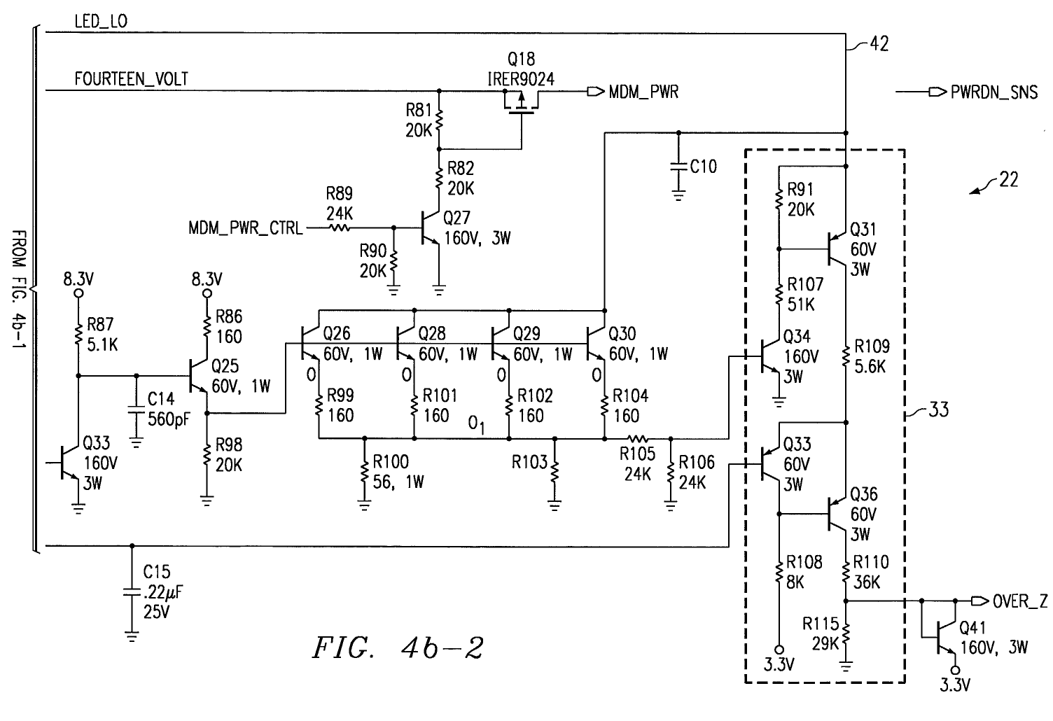

Referring now to FIG. 3, there is shown the 3.3 volt logic circuitry 64. The control circuit 64 is seen to include a PLD shown at 70 selectively controlling the LED array 22. PLD 70 is seen to provide several control signals 52, 54, and 56 depicted as LED_{—}0, LED_{—}1, LED_{—}2, and PWM Z. These control signals, as shown in FIG. 4a, control the operation of various components including the LED arrays to establish LED configuration as a function of DC operating voltage. Control circuit 64 is also seen to provide a reference signal depicted as REF to the comparator 80. The level shifter 73, comprised of a transistor Q4 and resistors R20 and R23, level shifts from 8.3 v to 3.3 v. If the base of Q4 is at low (3.3 v), Q4 is on causing the voltage on the collector of Q4 to go high (3.3 v). If the base of Q4 is high (8.3 v), Q4 is off causing the collector if Q5 to go low (0 v). Therefore, the input to Q4 is 3.3 v to 8.3 v logic level, and the output of Q5 is 0 v to 3.3 v logic level.

Turning now to FIG. 4a, there is shown the LED array 22 comprised of the main LED array 24 as well as the LED strings 26, 28 and 30. Associated with each of the LED strings 26, 28 and 30 is a respective shunt FET shown as transistor Q9, Q8, and Q15, respectively. The associated control signals are provided to control transistors and ultimately the gate of the respective shunt FETs to control the enabling thereof. For purposes of discussion, the node between the main LED array 24 and the first LED string 26 is depicted as 80. Likewise, the node between the LED string 26 and 28 is shown as node 82, and the node between the LED string 28 and the LED string 30 is shown at 84.

During startup, Q8, Q9 and Q15 are on, bypassing LED strings 26, 28 and 30 allowing only LED string 24 to operate. An LED counter, embedded in the logic in 70, controlling LED_{—}0, LED_{—}1 and LED_{—}2 is set to binary 0 in this condition (LED_{—}0 low, LED_{—}1 low, LED_{—}2 low) forcing the highest voltage on node 42. Voltage detection circuitry 33 detects if the voltage at node 42 is greater than the voltage needed to allow the logic to operate through transistor Q21. If the voltage on node 42 is not too high, nothing changes and only LED string 24 turns on. If the voltage on node 42 is higher than needed to operate the logic, then the LED counter increments to binary 1 (LED_{—}0 high, LED_{—}1 low, LED_{—}2 low) forcing a slightly lower voltage on node 42. Voltage detection circuitry 33 detects if the voltage at node 42 is greater than the voltage needed to allow the logic to operate through transistor Q21. If the voltage on node 42 is not too high, nothing changes and only LED string 24 and 30 turn on. If the voltage on node 42 is higher than needed to operate the logic, then the LED counter increments to binary 2 (LED_{—}0 low, LED_{—}1 nigh, LED_{—}2 low) forcing a slightly lower voltage on node 42. This process continues until an appropriate voltage on node 42 is established, or until the LED counter counts up to binary 7, at which point the cycle stops and all LED strings are on. Since the reconfiguration cycle takes only 15 to 105 micro-seconds, there is no flicker in the LED array visible to the human eye. The reconfiguration cycle can be started at any time during the LED light operation to allow the LED strings to reconfigure with changing operating voltage, or it can be done only during a power-up condition.

The eight states of operation just described are depicted in the table below.

| DC Voltage Range | LED_0 | LED_1 | LED_2 |
|---|---|---|---|
| Over 46 | 1 | 1 | 1 |
| 46-43 | 0 | 1 | 1 |
| 43-40 | 1 | 0 | 1 |
| 40-37 | 0 | 0 | 1 |
| 37-34 | 1 | 1 | 0 |
| 34-30 | 0 | 1 | 0 |
| 30-27 | 1 | 0 | 0 |
| Under 27 | 0 | 0 | 0 |

The LEDs of array 22 that are in the on state as determined by PLD 70 are PWM controlled by the PLD 70 via a signal PWM controlling the voltage at node 42. Control signal PWM controls the duty cycle at node 42 during the logic low state to create a voltage differential across the enabled LEDs and node 42. As shown, a PWM control circuit 86 is coupled to the DC voltage source 40. A Zener diode and schottky diodes shown as ZWD_{—}2, D2, and D6 establishes approximately a 9.0 volt signal to the base of transistor Q21, thus, due to the voltage drop across the base-emitter junction, provides roughly an 8.3 volt signal to the base of transistor Q33. Transistor Q33 and the associated emitter resistor provide a Schmitt Trigger that level shifts down to 3.3 v through resistors R110 and R115 similar to the previously described level shifter.

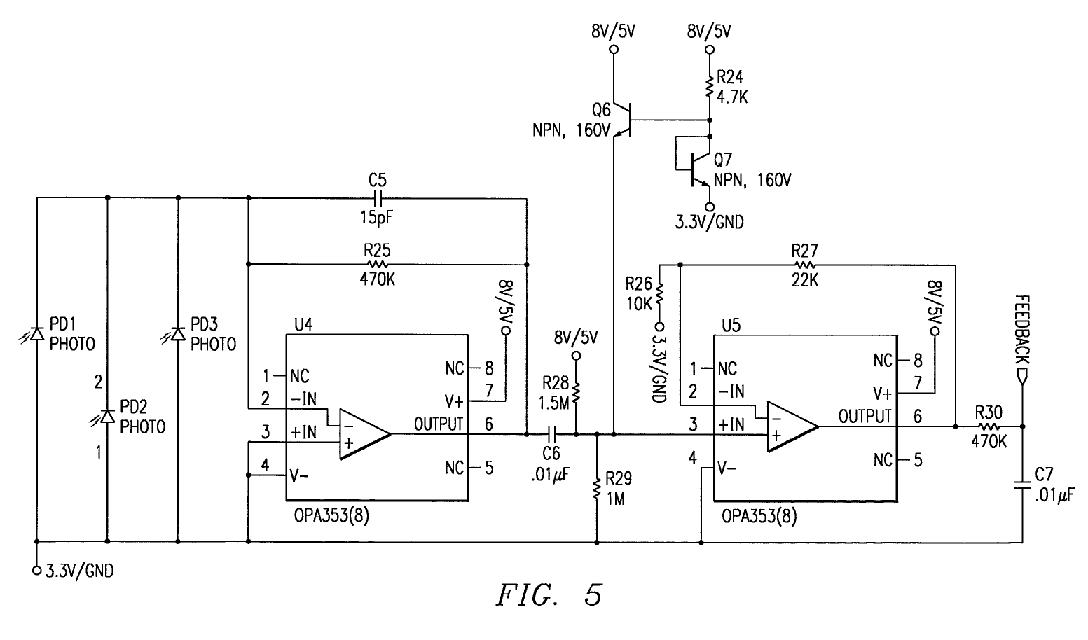

Referring now to FIG. 5, in view of FIG. 3, there is shown three photo diodes depicted as PD4, PD5, and PD6 all connected in parallel and providing an electrical control signal as a function of detected LED light to PLD 70. A pair of operational amplifiers 90 and 92, together with the photo diodes, provide a feedback signal to the PLD 70 for selectively establishing the light output of the LED array 22 through PWM control. For instance, during brighter LED light conditions, such as newer LEDs or low temperature, as detected by the photo diodes and recognized by the PLD 70, the PLD 70 may decrease the duty cycle of the PWM cycle to decrease the overall light intensity of the LED array 22. Conversely, during darker LED light conditions, such as older LEDs or higher temperatures, little light is detected by the photo diodes and hence, a smaller signal indicative thereof is provided to PLD 70 by the photo diodes. Responsively, the PLD 70 may increase the duty cycle of the PWM control to increase the overall light intensity of the LED array 22.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A light apparatus comprising:
a first rail having a first voltage;
a reference node having a reference voltage;
a first set of LEDs coupled to said reference node;
a second set of LEDs coupled between said first LED set and said first rail; and
a control circuit selectively controlling said second set of LEDs as a function of said first voltage relative to said reference voltage.

2. The light apparatus of claim 1 wherein said control circuit switches said second set of LEDs off when said first voltage falls below a predetermined minimum with respect to said reference voltage.

3. The light apparatus of claim 2 further comprising a third set of LEDs coupled between said second LED set and said first rail.

4. The light apparatus of claim 3 wherein said control circuit selectively controls said third set of LEDs as a function of said first voltage relative to said reference voltage.

5. The light apparatus of claim 4 wherein said first LED set, said second LED set, and said third LED set are connected in series, wherein said control circuit selectively shunts said third LED set or both said second and third LED set as a function of said reference voltage.

6. The light apparatus of claim 1 wherein said control circuit further comprises a voltage detect circuit detecting said reference voltage, wherein said control circuit selectively controls said LED sets as a function of said detected reference voltage.

7. The light apparatus of claim 1 further comprising logic circuitry coupled between said reference node and a second voltage rail having a second voltage.

8. The light apparatus of claim 7 wherein said logic circuitry comprised a first logic circuit and a second logic circuit coupled in series to provide stacked logic.

9. The light apparatus of claim 7 further comprising a voltage regulator coupled between said logic circuitry and said first set of LEDs.

10. The light apparatus of claim 9 wherein said voltage regulator regulates the reference voltage provided to said first set of LEDs, the reference voltage varying as a function of the first rail first voltage.

11. The light apparatus of claim 10 wherein said voltage regulator regulates the reference voltage such that only said first LED set is enabled for a first predetermined reference voltage, and such that said second set of LEDs is enabled for a second predetermined reference voltage.

12. The light apparatus of claim 1 wherein said control circuitry comprises a first shunt coupled across said first set of LEDs, and a second shunt coupled across said second set of LEDs, said shunts selectively shunting said respective set of LEDs as a function of said first voltage.

13. The light apparatus of claim 12 wherein said shunts each comprise a transistor.

14. The light apparatus of claim 13 wherein said shunts each comprise a FET.

15. The light apparatus of claim 1 further including a voltage level shifter disposed between said control circuit and said first set of LEDs.

16. A method of operating a LED apparatus including a plurality of LED sets coupled in series between a reference voltage and a rail voltage, comprising the steps of:
selectively powering the sets of LEDs as a function of the rail voltage with respect to the reference voltage.

17. The method of claim 16 wherein only one set of LEDs is enabled for a first predetermined rail voltage, and an additional set of LEDs is also enabled for a second predetermined rail voltage being greater than the first predetermined rail voltage.

18. The method of claim 17 wherein the LED apparatus comprises at least three sets of LEDs, further comprising the step of selectively enabling one, two or all three sets of LEDs as a function of the rail voltage with respect to the reference voltage.

19. The method of claim 16 wherein the LED apparatus includes a logic circuitry disposed between a second rail voltage and said reference voltage, comprising the step of regulating the reference voltage as a function of the first rail voltage.

20. The method of claim 19 wherein said reference voltage decreases as a function of said first rail voltage decreasing.
